(19) United States
(12) Patent Application Publication
(10) Pub. No.: US 2022/0217562 A1
(43) Pub. Date: Jul. 7, 2022

(54) Multiple Concurrent Gap Configuration

(71) Applicant: MediaTek Singapore Pte. Ltd., Singapore (SG)

(72) Inventors: Zhixun Tang, Beijing (CN); Tsang-Wei Yu, Hsinchu City (TW); Chun-Fan Tsai, Hsinchu City (TW)

(21) Appl. No.: 17/568,663

(22) Filed: Jan. 4, 2022

Related U.S. Application Data
(63) Continuation of application No. PCT/CN2020/070165, filed on Jan. 4, 2021.

(30) Foreign Application Priority Data
Dec. 2, 2021 (CN) 202111460265.6

(51) Int. Cl. H04W 24/10; H04W 24/08; H04W 8/24

(52) U.S. Cl. CPC H04W 24/10; H04W 8/24; H04W 24/08

(57) ABSTRACT

Apparatus and methods are provided for multiple concurrent gap configuration. In one novel aspect, the UE obtains the concurrent gap configuration which configures a concurrent measurement gap and one or more associated usages for the concurrent measurement gap, configures the concurrent measurement gap. In one embodiment, the UE reports a UE concurrent gap support capability to the wireless network indicating a concurrent measurement gap is supported by the UE and/or indicates one or more associated usages supported by the UE. In another embodiment, a measurement prioritization is performed when the concurrent measurement gap overlaps with another MG. The measurement prioritization is based on a measurement priority indication from the NW or determined by the UE or based on a set of preconfigured multiple gap sharing factors indicating a set of percentages for each corresponding measurement gap.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2020/070165, titled “Methods and apparatus for Multiple Concurrent Gap Configuration,” with an international filing date of Jan. 4, 2021. This application claims priority under 35 U.S.C. § 119 from Chinese Application Number CN 202111460265.6 titled “Multiple Concurrent Gap Configuration” filed on Dec. 2, 2021. The disclosure of each of the foregoing documents is incorporated herein by reference.

### TECHNICAL FIELD

The disclosed embodiments relate generally to wireless communication, and, more particularly, to methods and apparatus for multiple concurrent gaps configuration.

### BACKGROUND

Mobile networks communication continues to grow rapidly. The mobile data usage will continue skyrocketing. New data applications and services will require higher speed and more efficient. Large data bandwidth application continues to attract more consumers. The efficiency and quick adaptation of new standards are key to the mobile network. With the rapid development of the mobile network, the design of measurement gap, which suspends communication to give the mobile stations a gap period to perform measurement, requires more flexibility and efficiency.

In the current new radio (NR) system, only single measurement gap (MG) pattern can be configured within one measurement period for single UE, if the UE supports per-UE MG only or single frequency range (FR), if the UE supports per-FR MG. Consequentially, the network must configure the reasonable synchronization signal block (SSB)-based Measurement Timing configuration (SMTC) offset to align the SMTC windows for different measurement objects (MO) into the MG. At the same time, all the inter-RAT MOs and other MOs of reference signal (RS) will be measured with the timing alignment in SMTC window. The single MG will be used for different measurement purposes, such as inter-RAT measurements, positioning or CSI-RS measurements. The delay for each MO will be extended by the scaling factor Carrier-specific scaling factor (CSSF) within the gap. When all the frequencies are measured in the same MG, the short SMTC of frequency layers won't be utilized sufficiently. This adds the complexity for the measurement and is not flexible.

Improvements and enhancements are required to configure and perform measurement more efficiently.

### SUMMARY

Apparatus and methods are provided for multiple concurrent gap configuration. In one novel aspect, the UE obtains the concurrent gap configuration which configures a concurrent measurement gap and one or more associated usages for the concurrent measurement gap, configures the concurrent measurement gap based on the concurrent gap configuration and performs one or more measurements corresponding to the one or more associated usages in the concurrent measurement gap. In one embodiment, one or more MOs for a same RAT, one or more MOs for different RATs, SSB periodicity specific, CSI-RS specific, positioning reference signal (PRS) specific, inter-RAT specific, new radio (NR) specific, clear channel assessment received signal strength indicator (CCA RRSI) specific, inter-frequency specific, network controlled small gap (NCSG) specific, and NR unlicensed (NR-U) specific. In one embodiment, the NW configures a pair of MGRP, MGL, offset and associated usages are configured together with the concurrent gap in GapConfig. In one embodiment, the UE reports a UE concurrent gap support capability to the wireless network indicating a concurrent measurement gap is supported by the UE. The UE concurrent gap support capability further indicates one or more associated usages supported by the UE. In another embodiment, a measurement prioritization is performed when the concurrent measurement gap overlaps with a configured different first measurement gap. In one embodiment, the measurement prioritization is based on a measurement priority indication received from the NW in a RRC message. In another embodiment, the measurement prioritization is determined by the UE. In yet another embodiment, the measurement prioritization is based on a set of preconfigured multiple gap sharing factors indicating a set of percentages for each corresponding measurement gap.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with multiple concurrent gap configuration for the measurement.

FIG. 2 illustrates a top level flow diagram of the concurrent gap configuration with master node and secondary node and reporting of UE capability for the concurrent gap.

FIG. 3 illustrates example diagrams of configuring the associated usage of the concurrent gap as SSB periodicity specific.

FIG. 4 illustrates example diagrams of configuring the associated usage of the concurrent gap as inter-RAT specific.

FIG. 5 illustrates example diagrams of configuring the associated usage of the concurrent gap as CSI-RS specific or PRS specific.

FIG. 6 illustrates exemplary diagrams for performing a measurement prioritization when the concurrent measurement gap overlaps with a configured different measurement gap.

FIG. 7 illustrates an exemplary flow chart for multiple concurrent gap configurations.

### DETAILED DESCRIPTION

Reference will now be made in detail to some embodiments of the invention, examples of which are illustrated in the accompanying drawings.

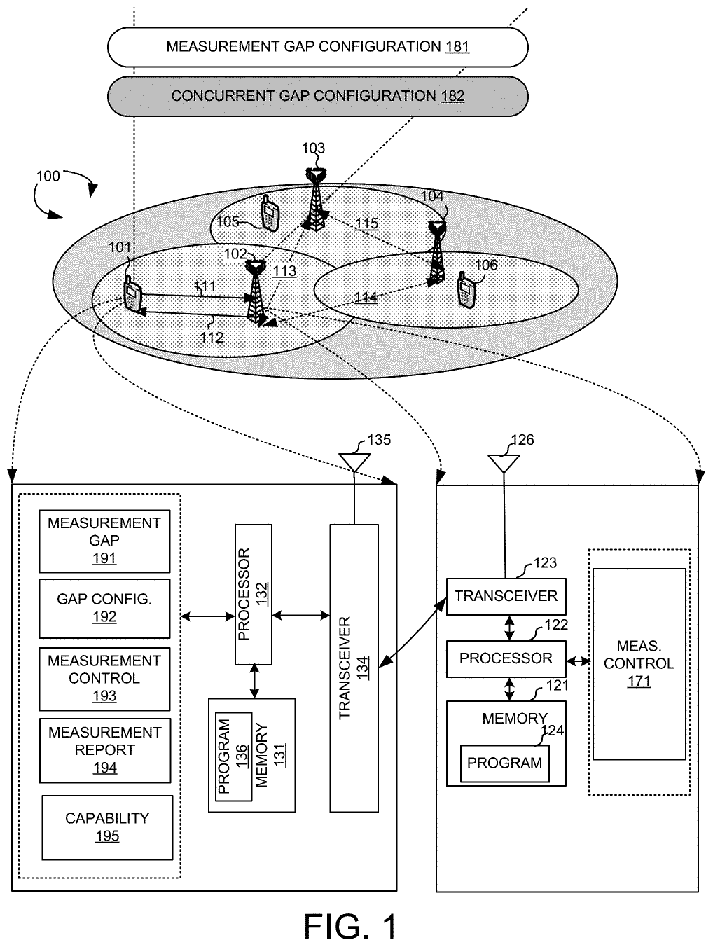

FIG. 1 illustrates a system diagram of a wireless communication system 100 with multiple concurrent gaps configuration for the measurement. Wireless communication system 100 includes one or more wireless networks. Each of the wireless communication network has fixed base infrastructure units, such as receiving wireless communications devices or base unit 102 103, and 104, forming wireless networks distributed over a geographical region. The base unit may also be referred to as an access point, an access terminal, a base station, a Node-B, an eNode-B, a gNB, or other terminology used in the art. The base unit can be an implementation of a gNB in New Radio (NR) of a fifth generation (5G) system. The 5G NR is a radio interface specified in communication standards developed by the 3rd Generation Partnership Project (3GPP). Each of the base unit 102, 103, and 104 serves a geographic area. The base unit performs beamforming in the NR network. Xn interface connections 113, 114 and 115 connect the non-co-located receiving base units, such as 102, 103, and 104. These connections can be either ideal or non-ideal.

A wireless communications device 101 in wireless communication system 100 is served by base station 102 via uplink 111 and downlink 112. Other UEs 105 and 106 are served by different base stations. UEs 105 is served by base station 103. UE 106 is served by base station 104. With a single measurement gap configuration for multiple MOs, the measurement delay for each MO will be extended. For example, there are four inter frequencies. f1, f3 have short SMTC periodicities, and f0, f2 have long SMTC periodicities. Although f1, f3 have short SMTCs, these two frequency layers have to share the same MG with other two frequency layers which have longer SMTCs. Owing to all the inter frequencies will be measured with the scaling factor N=4, the measurement delay for each MO will be extended. Prioritizing some specific radio access technologies (RATs) can improve the MG sharing mechanism. For example, the inter frequency f3 can share the same MG with NR frequencies. NW cannot prioritize the measurement for inter frequency f3. This frequency layer's measurement has to be limited within the SMTC window and share the MG with other NR frequencies. The measurement delay will also be extended due to gap sharing. In other networks, the NR CSI-RS, positioning RS (PRS) measurement were also introduced. The CSI-RS, PRS measurement will also share the same MG with SSB measurement. However, CSI-RS and PRS can have different configurations with SSB. Due to SSB-based measurement, the MG must align with SMTC window. It implies the CSI-RS, PRS configuration will be limited in the same SMTC window to share the single MG. The flexible configuration for CSI-RS and PRS cannot be fully utilized by NW.

In one novel aspect, new concurrent MG is configured. Associated usages for the concurrent measurement gap are also configured. In one example, the UE 101 is configured to perform measurement base on a measurement gap configuration 181 from a base station 102. When UE 101 supports the new capability of concurrent gap, the UE 101 is simultaneously configured to perform measurement base on a concurrent gap configuration 182 from base station 102. Accordingly, measurement gap configuration 181 and concurrent gap configuration 182 can be configured between the UE 101 and the base station 102. Depending on capability of the UE 101, different gap patterns can be configured.

FIG. 1 further shows simplified block diagrams of wireless device/UE 101 and base station 102 in accordance with the current invention.

Base station 102 has an antenna 126, which transmits and receives radio signals. A RF transceiver module 123, coupled with the antenna 126, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as a measurement control circuit 171 that configures concurrent measurement gap and implements the concurrent measurement gap functions.

UE 101 has an antenna 135, which transmits and receives radio signals. A RF transceiver module 134, coupled with the antenna 135, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

UE 101 also includes a set of control modules that carry out functional tasks. These control modules can be implemented in software, firmware and hardware. A measurement gap module 191 that obtains a concurrent gap configuration in a wireless network, wherein the concurrent gap configuration configures a concurrent measurement gap and one or more associated usages for the concurrent measurement gap. A gap configuration module 192 configures the concurrent measurement gap based on the concurrent gap configuration. A measurement control module 193 performs one or more measurements corresponding to the one or more associated usages for the concurrent measurement gap during the configured concurrent measurement gap. A measurement report module 194 transmits a measurement report to the wireless network including one or more measurement results upon detecting one or more configured triggering events. A capability module 195 reports a UE concurrent gap support capability to the wireless network indicating a concurrent measurement gap is supported by the UE.

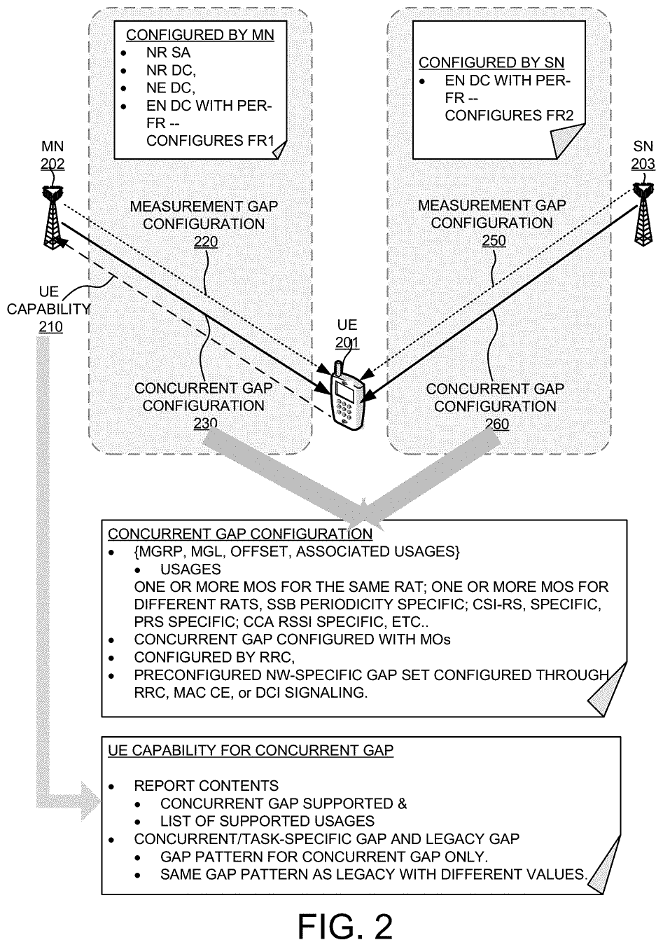

FIG. 2 illustrates a top-level flow diagram of the concurrent gap configuration with master node and secondary node and reporting of UE capability for the concurrent gap. A UE 201 is connected with a wireless network. In one embodiment, UE 201 is connected with a master node (MN) 202 and a secondary node (SN) 203. In one novel aspect, UE 201 reports a UE concurrent gap support capability to the wireless network indicating a concurrent measurement gap is supported by the UE. The UE 201 obtains a concurrent gap configuration from the wireless network and performs measurement accordingly.

In one embodiment, at step 210, UE 201 reports a UE concurrent gap support capability to MN 202. The UE concurrent gap support capability indicates a concurrent measurement gap is supported by the UE. The UE concurrent gap support capability further indicates one or more associated usages supported by the UE. For example, UE 201 reports a supported usage list. The possible usages include one or more MOs for a same radio access technology (RAT), one or more MOs for different RATs, one or more types of SSB periodicities, channel state information reference signal (CSI-RS) specific, positioning reference signal (PRS) specific, new radio (NR) specific, clear channel assessment (CCA) received signal strength indicator (RSSI) specific, inter-frequency specific, network controlled small gap (NCSG) specific, and NR unlicensed (NR-U) specific. An exemplary usage list contains {SSB-periodicity specific, NR specific, CSI-RS specific, PRS specific, CCA RSSI specific, Intra/inter-frequency specific, NCSG specific, etc.}. For the supported gap pattern, UE will re-use the gap pattern reporting for legacy gap. The supported gap pattern reported by UE will be applied for both legacy gap and Task-specific gap.

In another embodiment, UE 201 reports the supported gap pattern for the task-specific/concurrent gap only. This gap pattern list is independent of the legacy gap. An independent gap pattern for concurrent gap can supply more flexible for UE to support this new feature. For example, UE will report the supported gap pattern for concurrent gap only can be an alternative solution for gap pattern. Alternatively, The UE can report the same gap pattern list as legacy gap, but with different values.

The network (NW), at step 220, through MN 202, configures legacy gap with gap pattern {measurement gap repetition period (MGRP), measurement gap length (MGL), and offset} for UE 201. Alternatively, NW, at step 250, configures the legacy gap through SN 203, with the gap pattern {MGRP, MGL, and offset}. In one embodiment, the NW configures the concurrent gap with associated usages through RRC message. At step 230, the NW configures the associated usages together with the concurrent measurement gap based on radio resource control (RRC) message from MN 202. Similar with legacy gap, a pair of MGRP, MGL and offset shall be configured together with the concurrent measurement gap in GapConfig. The NW can also configure the concurrent gap pattern, at step 260, based on RRC message from SN 203. In another embodiment, the NW configures the concurrent/task-specific gap together with MOs and related RSs. For example, if NW wants to configure the usage of the concurrent gap as SSB periodicity specific, the concurrent gap configuration configures the MGRP, MGL and offset for the concurrent measurement gap to be associated with the target NR MOs with RS configuration as SSB. If NW wants to configure the usage of the concurrent gap as for different RATs, it configures the MGRP, MGL, offset for the concurrent measurement gap to be associated with the target multiple RAT MOs. In yet another embodiment, a NW-specific gap set is configured by RRC message. Each element in the NW-specific gap set includes the associated usage, MGRP, MGL and offset. In one embodiment, the NW further uses RRC message, MAC CE command or DCI signaling to dynamically indicate the gap usage and gap pattern for different purposes. For example, the NW configures a NW-specific gap set {associated usage, MRGP, MGL, offset} by RRC message as follow. Set-0: {Inter-frequency specific, 40, 6, 5}, Set-1: {CSI-RS specific, 20, 3, 0} etc. Subsequently, the NW uses the MAC-CE command to indicate set-0 or set-1 will be used for NW-specific gap.

In one embodiment, the concurrent gap is configured by MN 202 of the wireless network when UE 201 is connected with a system including an NR standalone (SA), an NR-dual connectivity (DC), or an NR-E-UTRA (NE) DC mechanism. When the UE supports per-UE gap, MN will configure the measurement gap. When UE supports per-FR gap, MN will configure the gap for FR1 and SN will configure the gap for FR2. In one embodiment, the UE may inherit the gap configuration mechanism from legacy design. When UE 201 is connected with a system including EN-DC with per-FR gap supported by the UE, MN 202 configures an FR1 of the concurrent measurement gap and SN 203 configures an FR2 of the concurrent measurement gap. When UE 201 supports per-UE gap, the concurrent gap can be configured by MN 202 only. In NR SA, NR-DC, or NE-DC, the measurement gap will always be configured by MN. Obviously, the concurrent gap shall be configured from MN 202 only. In other embodiments, the configuration of concurrent gap which shall be agnostic of the NW's deployment can be always from MN only.

In another embodiment, in EN-DC or NE-DC, if inter-frequency layer is configured to be monitored, only measurement gap pattern #0 and #1 can be used for per-FR gap in E-UTRA and FR1, or for per-UE gap. When UE supports concurrent/task-specific gap for NR specific usage, only measurement gap pattern #0 and #1 can be used for legacy gap, but it can be naturally to permit all reported gap patterns for concurrent/task-specific gap. In Rel-16, some new mandatory gaps were introduced for NR-only measurements to avoid the impact to legacy measurements. The new mandatory gaps will be applied when no LTE serving cells and no inter-frequency MOs. In one embodiment, UE 201 extends the mandatory gaps capability for the concurrent gap configuration. When UE 201 reports to support ‘supportedGapPattern-NRonly’ and the concurrent/task-specific gap is configured with usage of inter-frequency measurements, NR-only measurement can be always applied for legacy gap because only NR MOs will be measured in legacy gap.

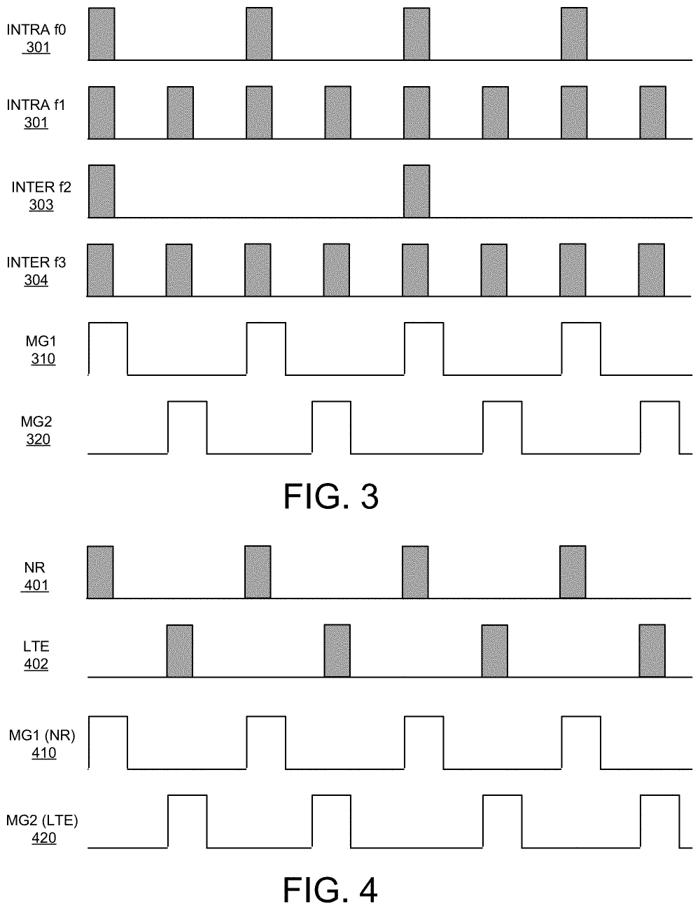

In one novel aspect, concurrent gap configuration configures a concurrent measurement gap and one or more associated usages for the concurrent measurement gap. FIG. 3 to FIG. 5 illustrates exemplary usages for the concurrent measurement gap.

FIG. 3 illustrates example diagrams of configuring the associated usage of the concurrent gap as SSB periodicity specific. The intra-frequency's MOs and inter-frequency's MOs may have different SMTC configurations. In one embodiment, NW re-groups the MOs based on different SMTC periodicities. Intra frequency f0 301 and intra frequency f1 302 has different SSB periodicities. Inter frequency f2 303 and inter frequency f3 304 has different SSB periodicities. Measurement gaps MG1 310 and MG2 320 are configured with different offsets to cover intra frequency f0 301, intra frequency f1 302, inter frequency f2 303, and inter frequency f3 304. Other MG configurations, such as different MGL and/or MGRP can be used based on the SSB patterns for the MOs. A concurrent measurement gap is configured to be associated with one or more specific SSB periodicities, or SSB periodicity specific.

FIG. 4 illustrates example diagrams of configuring the associated usage of the concurrent gap for different RATs. When the UE needs to support at least seven LTE frequencies based on the measurement capability, the different RAT MOs will share the same MG resource with NR frequencies. However, the physical layer's structure for different RAT measurements is different with NR system. These different RAT MOs can be measured at any time based on PSS/SSS/CRS design in LTE. In one embodiment, a RAT specific MG can offload the MG sharing between NR frequency layers and inter-RAT. This RAT specific MG's configuration can be very flexible. It can be configured at any occasion to avoid the colliding with NR SMTC window. The UE is configured with NR MO 401 and LTE MOs 402. In one embodiment, the concurrent gap can be associated with one or more MOs of different RATs, such as MG1 410 for NR and MG2 420 for LTE. In another embodiment, the concurrent gap can be associated with one or more MOs of the same RATs.

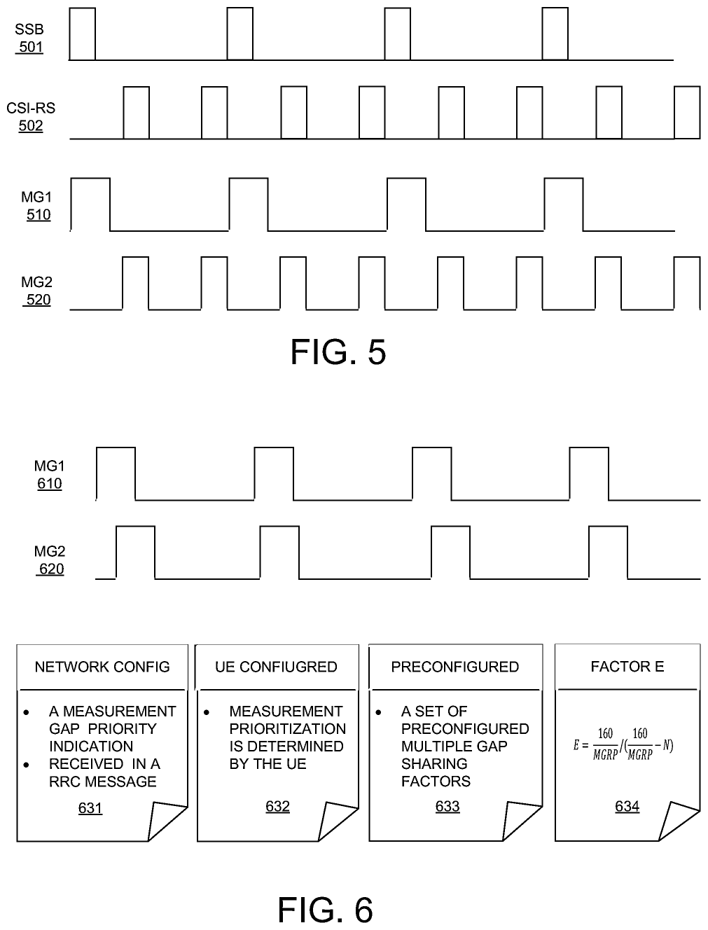

FIG. 5 illustrates example diagrams of configuring the associated usage of the concurrent gap as CSI-RS specific or PRS specific. CSI-RS and PRS MOs also share the MG with SSB-based measurements. However, CSI-RS and PRS can have very flexible and different configurations with SSB. For example, compared with SSB-based measurements, CSI-RS measurements may have a shorter measurement periodicity or PRS may have a longer MGL. To fully utilizing the flexible configuration for the RSs except the SSB, a new MG is configured for these RSs' measurement. As illustrated, the UE is configured with SSB MOs 501 and CSI-RS MOs 502. MG1 510 is configured for SSB MOs 501. MG2 520 is configured for CSI-RS MOs 502. MG1 510 and MG2 520 have different MGL and MGPR. The concurrent measurement gap gives the flexibility with associated usages for CSI-RS specific and/or PRS specific.

In other embodiments, the associated usages for the concurrent measurement gap further includes clear channel assessment received signal strength indicator (CCA RRSI) specific, inter-frequency specific, network controlled small gap (NCSG) specific, and NR unlicensed (NR-U) specific. RSSI measurements for NR-U may collide with SSB based measurements. A similar sharing rule for NR-U RSSI measurements within MG will also be agreed. In one embodiment, the new concurrent MG is configured to measure NR-U's RSSI to avoid the limitation on RSSI configuration and sharing the MG with NR SSB-based measurements. In one embodiment, the pre-configured MG can be activated/deactivated based on serving cells' bandwidth part (BWP) switching. Thus, NW can also configure this concurrent MG for intra-frequency measurements only. The benefit is NW can still schedule data when all the serving cells including SSB for measurements. In another embodiment, the associated usage is NCSG specific. The UE will report which inter-frequency layers can be measured without MG but with interruption. When these frequency layers will be measured, the interruption will only happen before or after the measurement occasions. Thus, when NW clearly configures a specific NCSG gap for these frequency layers, the data dropping rate can be reduced.

In one embodiment, a new carrier specific scaling factor (CSSF_{within_newGap,i}) for this new concurrent/task-specific gap shall be introduced. The CSSF_{within_newGap,i} for measurement object i is applied to following measurement types: the related frequency layers based on the usage configuration for the new concurrent/task-specific gap; intra-frequency measurement object with no measurement gap, when all of the SMTC occasions of this intra-frequency measurement object are overlapped by the new Task-specific gap; and inter-frequency measurement with no measurement gap, when all of the SMTC occasions of this inter-frequency measurement object are overlapped by the new Task-specific gap, if UE supports interFrequencyMeas-NoGap-r16. The UE is expected to conduct the measurement of this measurement object #i only within the new Task-specific gaps.

FIG. 6 illustrates exemplary diagrams for performing a measurement prioritization when the concurrent measurement gap overlaps with a configured different measurement gap. A configured MG1 610 overlaps with a configured MG2 620. MG1 610 and MG2 620 can be partially overlapped or fully overlapped. When MGLs from two gaps are partially or fully overlapping, there is a collision between the two MGs. When these two gaps have different MGRP and offset configurations, the new concurrent/task-specific gap may partially or fully overlap with the legacy gap. The main purpose on introducing the new concurrent/task-specific gap is NW prefers to prioritize some frequencies measurements which will be measured in new concurrent/task-specific gap.

In one embodiment 631, when the new concurrent/task-specific gap collides with the legacy gap, the NW can indicate which gap has higher priority by RRC signaling. For example, at time occasion T1, the NW configures the element of ‘high priority’ as the legacy gap. At time occasion T2, the NW configures the element of ‘high priority’ as new concurrent gap. In another embodiment 632, The UE determines the prioritization when the MG collides. The frequency layer in which gap can be measured is up to UE implementation. In yet another embodiment 633, Prioritization is based on a set of preconfigured multiple gap sharing factors indicating a set of percentages for each corresponding measurement gap. The NW configures multiple gap sharing factors to indicate the percentage for each gap by RRC signaling ‘MultipleGapSharingScheme’. For Example:

K_{legacy}=X/100

K_{TaskGap}=(100−X)/100

When NW indicates ‘00’, it means K_{legacy}=0, K_{TaskGap}=1. When NW indicates ‘11’, it means K_{legacy}=1, K_{TaskGap}=0. The exemplary table is as follows.

| MultipleGapSharingScheme | Value of X (%) |
|---|---|
| ‘00’ | 0 |
| ‘01’ | 25 |
| ‘10’ | 50 |
| ‘11’ | 100 |

It is left to UE implementation to determine which measurement gap sharing scheme in the table to be applied, when MeasGapSharingScheme is absent and there is no stored value in the field. In one embodiment 634, factor E is used to prioritize the MG. When the new concurrent/task-specific gap collides with the legacy gap, the frequency layers which are configured to be measured within new concurrent/task-specific gap has higher priority than the frequency layers which will be measured in legacy gap. Naturally, the measurements of frequency layers in legacy gap will be extended. The extension factor E can be

$$E = \frac{160}{M G R P} / ( \frac{160}{M G R P} - N ) .$$

Where, N is the number of legacy gap occasions which are colliding with new Task-specific gap.

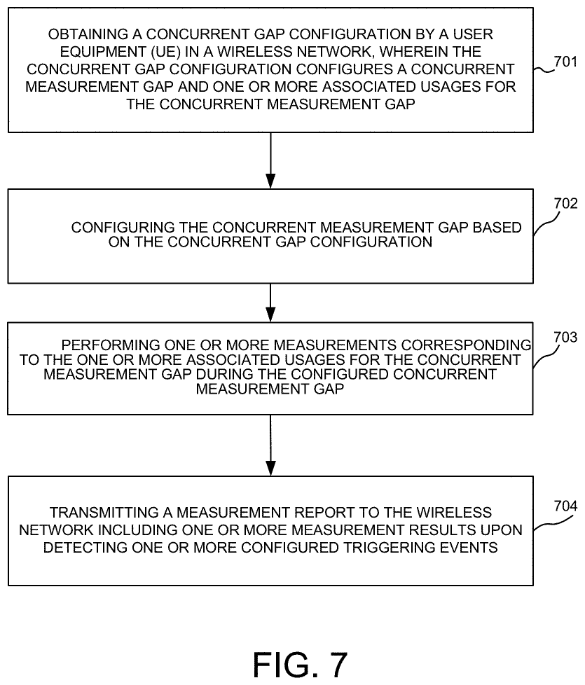

FIG. 7 illustrates an exemplary flow chart for multiple concurrent gap configurations. At step 701, the UE obtains a concurrent gap configuration in a wireless network, wherein the concurrent gap configuration configures a concurrent measurement gap and one or more associated usages for the concurrent measurement gap. At step 702, the UE configures the concurrent measurement gap based on the concurrent gap configuration. At step 703, the UE performs one or more measurements corresponding to the one or more associated usages for the concurrent measurement gap during the configured concurrent measurement gap. At step 704, the UE transmits a measurement report to the wireless network including the one or more measurement results upon detecting one or more configured triggering events.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
obtaining a concurrent gap configuration by a user equipment (UE) in a wireless network, wherein the concurrent gap configuration configures a concurrent measurement gap and one or more associated usages for the concurrent measurement gap;
configuring the concurrent measurement gap based on the concurrent gap configuration;
performing one or more measurements corresponding to the one or more associated usages for the concurrent measurement gap during the configured concurrent measurement gap; and
transmitting a measurement report to the wireless network including one or more measurement results upon detecting one or more configured triggering events.

2. The method of claim 1, wherein the associated usages for the concurrent measurement gap comprising at least one of: one or more measurement objects (MOs) for a same radio access technology (RAT), one or more MOs for different RATs, synchronization signal block (SSB) periodicity specific, channel state information reference signal (CSI-RS) specific, positioning reference signal (PRS) specific, new radio (NR) specific, clear channel assessment received signal strength indicator (CCA RRSI) specific, inter-frequency specific, intra-frequency specific, network controlled small gap (NCSG) specific, and NR unlicensed (NR-U) specific.

3. The method of claim 1, wherein the concurrent gap configuration further comprises a pair of measurement gap repetition period (MGRP), measurement gap length (MGL), and offset.

4. The method of claim 1, wherein one or more associated usages for the concurrent measurement gap is configured by associating one or more predefined Mos with the concurrent measurement gap.

5. The method of claim 1, wherein the concurrent gap configuration is configured by a master node (MN) of the wireless network when the UE is connected with a system comprising an NR standalone (SA), an NR-dual connectivity (DC), an NR-E-UTRA (NE) DC, or an E-UTRA NR (EN) DC with per-UE gap supported by the UE, and wherein when the UE is connected with a system of EN-DC with per-FR gap supported by the UE, the MN of the wireless network configures an FR1 of the concurrent measurement gap and a secondary node (SN) of the wireless network configures an FR2 of the concurrent measurement gap.

6. The method of claim 1, further comprising: reporting a UE concurrent gap support capability to the wireless network indicating the concurrent measurement gap is supported by the UE.

7. The method of claim 6, wherein the UE concurrent gap support capability further indicates one or more associated usages supported by the UE.

8. The method of claim 1, wherein a measurement prioritization is performed when the concurrent measurement gap overlaps with a configured different measurement gap.

9. The method of claim 8, wherein the measurement prioritization is performed based on a measurement priority indication received from the wireless network in a radio resource control (RRC) message.

10. The method of claim 8, wherein the measurement prioritization is determined by the UE.

11. The method of claim 8, wherein the measurement prioritization is performed based on a set of preconfigured multiple gap sharing factors indicating a set of percentages for each corresponding measurement gap.

12. A user equipment (UE), comprising:
a transceiver that transmits and receives radio frequency (RF) signals in a wireless network;
a measurement gap module that obtains a concurrent gap configuration in the wireless network, wherein the concurrent gap configuration configures a concurrent measurement gap and one or more associated usages for the concurrent measurement gap;
a gap configuration module that configures the concurrent measurement gap based on the concurrent gap configuration;
a measurement control module that performs one or more measurements corresponding to the one or more associated usages for the concurrent measurement gap during the configured concurrent measurement gap; and
a measurement report module that transmits a measurement report to the wireless network including one or more measurement results upon detecting one or more configured triggering events.

13. The UE of claim 12, wherein the associated usages for the concurrent measurement gap comprising at least one of: one or more measurement objects (MOs) for a same radio access technology (RAT), one or more MOs for different RATs, synchronization signal block (SSB) periodicity specific, channel state information reference signal (CSI-RS) specific, positioning reference signal (PRS) specific, new radio (NR) specific, clear channel assessment received signal strength indicator (CCA RRSI) specific, inter-frequency specific, intra-frequency specific, network controlled small gap (NCSG) specific, and NR unlicensed (NR-U) specific.

14. The UE of claim 12, wherein one or more associated usages for the concurrent measurement gap is configured by associating one or more predefined MOs with the concurrent measurement gap.

15. The UE of claim 12, wherein the concurrent gap configuration is configured by a master node (MN) of the wireless network when the UE is connected with a system comprising an NR standalone (SA), an NR-dual connectivity (DC), an NR-E-UTRA (NE) DC, or an E-UTRA NR (EN) DC with per-UE gap supported by the UE, and wherein when the UE is connected with a system of EN-DC with per-FR gap supported by the UE, the MN of the wireless network configures an FR1 of the concurrent measurement gap and an secondary node (SN) of the wireless network configures an FR2 of the concurrent measurement gap.

16. The UE of claim 12, further comprising a capability module that reports a UE concurrent gap support capability to the wireless network indicating the concurrent measurement gap is supported by the UE.

17. The UE of claim 16, wherein the UE concurrent gap support capability further indicates one or more associated usages supported by the UE.

18. The UE of claim 12, wherein a measurement prioritization is performed based on a measurement priority indication received from the wireless network in a radio resource control (RRC) message when the concurrent measurement gap overlaps with a configured different measurement gap.

19. The UE of claim 12, wherein a measurement prioritization is determined by the UE when the concurrent measurement gap overlaps with a configured different first measurement gap.

20. The UE of claim 12, wherein a measurement prioritization is performed based on a set of preconfigured multiple gap sharing factors indicating a set of percentages for each corresponding measurement gap when the concurrent measurement gap overlaps with a configured different first measurement gap.
